(19) United States
(12) Patent Application Publication
(10) Pub. No.: US 2005/0027654 A1
(43) Pub. Date: Feb. 3, 2005

(54) System and method for a business payment connection

(76) Inventor: Alexandra J. Adrian, Carlisle, MA (US)

Correspondence Address: AKC PATENTS, 215 GROVE ST., NEWTON, MA, 02466, US

(21) Appl. No.: 10/894,893

(22) Filed: Jul. 19, 2004

Related U.S. Application Data
(60) Provisional application No. 60/490,468, filed on Jul. 28, 2003.

(51) Int. Cl. G06F 17/60

(52) U.S. Cl. 705/40

(57) ABSTRACT

An online business payment method that provides credit and cash flow management for at least one seller of products or services, at least one buyer of the products or services, and a financial institution via a business payment system accessible via a network connection. The method includes first establishing a credit line for the buyer by the financial institution. Next, placing a purchase order for a product or service by the buyer to the seller and entering a purchase order number into the business payment system. Next, accepting the purchase order by the seller and providing the product or service to the buyer. Next, sending an invoice by the seller to the buyer and entering the invoice into the business payment system against the purchase order number. Next, approving the invoice by the buyer, entering the approval into the business payment system and notifying the financial institution of the approved invoice by the business payment system. Finally, approving payment of the approved invoice by the financial institution and paying the invoice by transferring money from the buyer's credit line to an account of the seller. The seller sets a payment term for the invoice and pays a seller's fee to the financial institution upon receipt of the invoice payment. The seller's fee depends upon the invoice payment term. The buyer pays interest to the financial institution when the invoice payment term is not met. Access to the online business payment system is secure and selective access permissions are defined for each member.

### CROSS REFERENCE TO RELATED CO-PENDING APPLICATIONS

This application claims the benefit of U.S. provisional application Ser. No. 60/490,468 filed on Jul. 28, 2003 and entitled SYSTEM AND METHOD FOR A BUSINESS PAYMENT CONNECTION, which is commonly assigned and the contents of which are expressly incorporated herein by reference.

### FIELD OF THE INVENTION

The present invention relates to a system and a method for a business payment connection, and more particularly to an online, software-based, business payment connection that incorporates online payment with credit and cash flow management.

### BACKGROUND OF THE INVENTION

Traditionally, businesses selling their goods and services to other businesses have accepted the fact that their buyers expect to be offered payment terms. Although this “trade credit” system is widely accepted, it is also widely acknowledged to be an inefficient and expensive system, that creates cash flow problems for all Business-to-Business sellers and service providers. This traditional business payment model has forced the seller of goods and services into the role of a reluctant banker.

In fact, 99% of small-to-medium businesses extend trade credit financing, thereby restricting available working capital. Typically, 40% of a company's balance sheet is tied up in accounts receivable resulting from long collection cycles. Often the collection cycles are over 65 days. As a result, cash flow is restricted, purchasing power of the seller is diminished, and severe limits are placed on commerce between businesses.

Furthermore, since the entire business system of sellers and buyers is connected, the buyers who chose to delay payment for goods and services ultimately suffer delays in the purchase of and payment for their own goods or services because prospective buyers have not received payment on their receivables. Therefore, this “trade credit” with long collection cycles results in slowing down the entire business system.

In addition, since most businesses lack the tools to effectively manage the credit and collection processes, extensive resources are expended and risk is often poorly managed. Further, the cost of this inefficient system is typically added to the price of the goods or services thereby hampering economic growth due to inflated prices.

A well known method for paying for goods and service both for businesses and consumers is the credit card method. Although widely accepted, credit cards have several disadvantages for both the sellers and the buyers. Sellers of goods or services who accept credit cards typically pay a fee to the card issuer in the range of 3%-4% of the purchase amount. They also have to pay a basic monthly fee for using the system. In addition, the card issuer may delay payment of the amount charged by the buyers to sellers for up to 10 days or more. Buyers, of course, have to pay the purchase amount in full or pay interest on the unpaid balance which can exceed 18% per year. Furthermore, businesses with little credit history or with poor credit rating do not usually qualify for a credit card or if they do a very low credit limit is usually imposed. Card issuers assume a great amount of risk because losses due to “loan” default can be significant.

Other prior art business payment methods include bartering and “factoring”. Bartering involves trading of services or goods between sellers and buyers. A common problem with bartering involves around the valuation of the exchanged goods and services. “Factoring” refers to receiving a loan from a lending institution using accounts receivable (A/R) as a collateral and then using the loan to pay for goods or services. This is both complex and expensive, since most lending institutions that provide the loans charge fees up to 15% of the accounts receivable amount. A prior art software based payment system utilizing the “factoring” method is the “Business Manager® product offered by Private Business, Inc. of Brentwood, Tenn. A combination of bartering and “factoring” used by a business network is described in U.S. application 2003/0023498, by Benton. According to this method a group of financial institutions and member businesses cooperate to establish a trading network in which member sellers accrue “derivatives” equal to the value of goods or services to member buyers, and then use the “derivatives” to purchase goods and services from other members of the network. This system is both complex and expensive and utilizes “derivatives” as a payment unit instead of currency. Again the problem of the “derivative” valuation exists.

Accordingly, there is a need for an easy to use and inexpensive business payment method and system that connects sellers, buyers and financial institutions and provides online payment, credit and cash flow management.

### SUMMARY OF THE INVENTION

In general, in one aspect, the invention features an online business payment method that provides credit and cash flow management for at least one seller of products or services, at least one buyer of the products or services, and a financial institution via a business payment system accessible via a network connection. The method includes first establishing a credit line for the at least one buyer by the financial institution. Next, placing a purchase order for a product or service by the at least one buyer to the at least one seller and registering a purchase transaction and entering a purchase order number into the business payment system. Next, accepting the purchase order by the at least one seller and providing the product or service to the at least one buyer. Next, sending an invoice by the at least one seller to the at least one buyer and entering the invoice into the business payment system against the purchase order number. Next, approving the invoice by the at least one buyer and entering the approval into the business payment system. Next, notifying the financial institution of the approved invoice by the business payment system and approving payment of the approved invoice by the financial institution. Finally, paying the invoice by transferring money from the at least one buyer's credit line to an account of the at least one seller. The business payment system provides a collaborative platform for the at least one seller, the at least one buyer and the financial institution for viewing status of the purchase transaction, the establishing of a credit line, the registering of the purchase transaction, the entering and accepting of a purchase order number, the entering and approving of the invoice, the notifying of the financial institution, the approving of payment and the paying of the invoice.

Implementations of this aspect of the invention may include one or more of the following features. The method further includes setting a payment term for the invoice by the at least one seller and the payment term may be 30 days, 45 day, 60 days, or 90 days. The method further includes paying a seller's fee to the financial institution by the at least one seller upon receiving said payment and the seller's fee depends upon the payment term and may be a percentage of the invoice. The method may further include paying interest to the financial institution for the credit line by the at least one buyer when the payment term is not met. The method may further include converting the credit line into a loan and paying interest to the financial institution for the loan by the at least one buyer when the payment term is not met. The method may further include purchasing insurance for the loan by the financial institution. The invoice approval and the transferring of money may occur within less than five day after the sending of the invoice to the at least one buyer. If after sending the invoice by the at least one seller to the at least one buyer further the invoice is not approved by the at least one buyer, the buyer notifies the at least one seller of an error in the invoice and the seller corrects the error in the invoice and resends the invoice to the at least one buyer. The process of establishing of a credit line includes login into the business payment system, accessing and filling out an online credit application and submitting the online credit application to the financial institution via the business payment system. Next, reviewing the credit application by the financial institution and approving the credit application by the financial institution and notifying the at least one buyer and the at least one seller of the approval. After the filling out of the online credit application further the financial institution may request and receive additional information from the at least one buyer. The method may further include referring at least a second buyer or a second seller to join the online business payment system. The at least one buyer, the at least one seller and the financial institution may access the business payment system via a secure login process and the access is controlled based on previously set permissions. The login process may include entering a user name and a password. The online business payment system may include a server connected to the network, and a business payment software. The server comprises a central processing unit and a storage medium, and the business payment software is stored in the storage medium and is adapted to run on the central processing unit. The business payment software includes instructions for performing the establishing of the credit line, the registering of the purchase transaction, the entering of the purchase order number and invoice, the approving of the invoice, the notifying the financial institution of the approved invoice and registering of the paying of the invoice. The business payment software includes a buyer's module, a seller's module, and a financial institution's module and the buyer's module, the seller's module, and the financial institution's module comprise a buyer's user interface, a seller's user interface and a financial institution's user interface, respectively, and are accessed and viewed by the at least one buyer, the at least one seller, and the financial institution, respectively, via a web browser. The business payment software further includes instructions for presenting an electronic dashboard for displaying information of the purchase transaction via the buyer's user interface, the seller's user interface and the financial institution's user interface. The information of the purchase transaction includes a status, a bank reference number, a purchase order number, an invoice number, a date, an amount, name of the at least one buyer and name of the at least one seller. The information of the purchase transaction is selectively viewed by the at least one buyer, the at least one seller and the financial institution based on previously set permissions. The buyer's module provides the functions of applying online for a line of credit, registering the purchase transaction, and reviewing the purchase transaction. The seller's module provides the functions of reviewing statue of new buyer application for a line of credit, and reviewing the purchase transaction. The financial institution's module provides the functions of receiving and reviewing new buyer application for a line of credit, reviewing the purchase transaction, and reviewing total credit line usage. The buyer's module, the seller's module and the financial institution's module further provide the function of referring a new buyer or a new seller. The network may be the Internet, a Virtual Private Network, a cable network, a data network, a telephone network, a private voice and data network, or a public voice and data network. The financial institution may be a bank, an investment company, a credit card company, a loan company, a money management company, and an insurance company. The purchase order may be place via telephone, mail, in person or online. The account of the at least one seller may be located in the financial institution.

In general, in another aspect, the invention features a business payment system that provides a collaborative platform for managing credit and cash flow between at least one seller of products or services, at least one buyer of the products or services and a financial institution. The business payment system includes an electronic dashboard for registering and displaying a purchase transaction for the products or services, an electronic application for establishing a line of credit for the at least one buyer at the financial institution wherein the line of credit is used for paying the at least one seller for the products or services, and means for receiving and sending communications from and to the business payment system, the at least one seller, the at least one buyer and the financial institution. The business payment system is accessed by the at least one buyer, the at least one seller and the financial institution via a secure network connection.

Implementations of this aspect of the invention may include one or more of the following features. The system further includes a server connected to the network and comprising a central processing unit and a storage medium for running and storing a business payment software, respectively, and the business payment software comprises the electronic dashboard, the electronic application for credit line and the communications means. The business payment software includes a buyer's module, a seller's module, and a financial institution's module and wherein the buyer's module, the seller's module, and the financial institution's module comprise a buyer's user interface, a seller's user interface and a financial institution's user interface, respectively, and are accessed and viewed by the at least one buyer, the at least one seller, and the financial institution, respectively, via a web browser. The communications include registering a purchase transaction, entering a purchase order number, entering an invoice number, entering approval of an invoice number, sending notification of the invoice approval, sending instruction to pay the invoice number, selecting a payment term, entering a user name and password, changing the user name and password, filling out and submitting a line of credit application and sending notification of status of the line of credit application. The purchase transaction includes a purchase order number, a transaction status, a financial institution reference number, an invoice number, a date, an amount, the buyer's name and contact information, the seller's name and contact information, and the financial institution's name and contact information. The purchase transaction is selectively viewed by the at least one buyer, the at least one seller and the financial institution based on previously set permissions.

Among the advantages of this invention may be one or more of the following. With the Business Payment Connection™ system (BPC™ system), the bank, sellers and buyers all benefit. Banks gain significant benefits in credit risk management, generating direct fee income, and improved business development using the Business Payment Connection™. Credit risk management is facilitated by Business Payment Connection™ in a number of ways. First, by the nature of the process, bank credit lines, granted to member buyers, are used in a closed loop environment to purchase either from a single supplier or multiple suppliers. These dedicated credit lines are focused on each transaction so exposure is limited. BPC™ system's Internet interface allows unique visibility and bank control over each transaction. Banks can now effectively monitor the entire transaction. Starting with the buyer's issuance of a purchase order (the amount of which is deducted from the buyer's available credit), the bank can follow the transaction to the seller's issuance of the related invoice and finally the buyer's acceptance of the goods or services, which initiates payment to the seller by the bank. Business Payment Connection™ can effectively increase bank revenue from both sellers and buyers. Sellers drive direct transaction fee income and generate increased deposits or investment dollars for the bank from their improved cash flow. Buyers generate interest income from credit lines that may be extended beyond the initial 30, 60 or 90-day terms. In addition, newly introduced member buyers can be cross-sold full banking relationships. Banks gain a competitive advantage by offering an industry leading business payment solution. They are perceived as a true business partner with clients by providing a solution that dramatically improves their cash flow and bottom line profitability. Business development efforts to acquire new high-quality clients are significantly enhanced using BPC™ system's “built-in-referral process”. Profitable relationships with an existing “customer's customers” are easily acquired. In addition, banks can use the product to connect with Certified Public Accountants (CPAs) as an effective referral source. CPAs can use Business Payment Connection™ in much the same way as member banks. CPAs can maintain “off-season” contact with their clients, demonstrate a unique solution to their customer's cash flow problems and work more closely with member banks. CPAs have also voiced an interest in becoming member sellers themselves, to hasten their own payment cycles. CPAs working together with a member bank is a very strong, perhaps the best, partnership for any bank.

Sellers increase their sales, cash flow and bottom line with an innovative A/R management solution. BPC™ system's member sellers can increase their sales by offering attractive payment terms of 30, 60 or 90 days same as cash. They can improve cash flow by receiving guaranteed payment (less related fees) within 2 days after an invoice and related goods/services are approved by the buyer regardless of the terms offered to qualified customers. Additionally, sales to member buyers typically save sellers money over traditional trade credit methods, eliminate bad debt expense and remove the unseen administrative costs related to doing business with non-paying customers. BPC™ system's fee structure is very affordable, keeping the cost of sales low. Business Payment Connection™ allows member banks easy tracking of all transaction and payment activity, securely online access including: Orders placed, Invoices paid, Disputes documented, Credits, Disbursement, and Activity management reporting.

Buyers gain purchasing convenience, save money, improve cash flow and their bottom line with an innovative vendor payment solution. Buyers gain purchasing convenience, save money and improve cash flow by being able to take advantage of extended payment terms of 30, 60 or 90 days same as cash that may be offered by a member seller. They can also choose to automatically extend payments by converting to a line of credit with member bank approval. Because payments are made immediately to sellers, buyers improve their credit rating and access to additional credit. Business Payment Connection™ makes it easy for buyers to be truly connected to their most important vendors.

The details of one or more embodiments of the invention are set forth in the accompanying drawings and description below. Other features, objects and advantages of the invention will be apparent from the following description of the preferred embodiments, the drawings and from the claims.

### BRIEF DESCRIPTION OF THE DRAWINGS

Referring to the figures, wherein like numerals represent like parts throughout the several views:

FIG. 1 is an overview diagram of the business payment system;

FIG. 2 is an overview diagram of a first embodiment of the business payment system of FIG. 1;

FIG. 3 is an overview diagram of a second embodiment of the business payment system of FIG. 1;

FIG. 4 is a transaction sequence diagram;

FIG. 5 is a transaction sequence diagram with an initially disputed invoice;

FIG. 6 is a transaction sequence diagram with a disputed diagram and no resolution;

FIG. 7 is a diagram for the process of evaluating an application;

FIG. 8 is a diagram for the process of transferring funds;

FIG. 9 is a screenshot of the login screen of the BPC™ system;

FIG. 10 is a screenshot of the seller's view of the electronic dashboard of the BPC™ system;

FIG. 11 is a screenshot of the bank rate and information screen of the BPC™ system;

FIG. 12 is a screenshot of the user's administration screen of the BPC™ system;

FIG. 13 is a screenshot of the referral screen of the BPC™ system;

FIG. 14 is a screenshot of the credit application screen of the BPC™ system;

FIG. 15 is a screenshot of the order tracker screen of the BPC™ system for a New PO;

FIG. 16 is a screenshot of the order tracker screen of the BPC™ system for an Open PO;

FIG. 17 is a screenshot of the invoice tracker screen of the BPC™ system;

FIG. 18 is a screenshot of the buyer's view of the electronic dashboard screen of the BPC™ system; and

FIG. 19 is a screenshot of the active invoice statement screen of the BPC™ system.

### DETAILED DESCRIPTION OF THE INVENTION

This invention provides an innovative business payment system and a method that efficiently connects buyers and sellers via the Internet using a member bank facilitated payment solution for performing purchase transactions. Utilizing this innovative business payment solution, member buyers can access a dedicated bank credit line to purchase goods and services from member sellers. The seller subsidizes the program by paying a small fee per transaction and gets paid by the bank immediately upon buyer acceptance of the purchased goods or services.

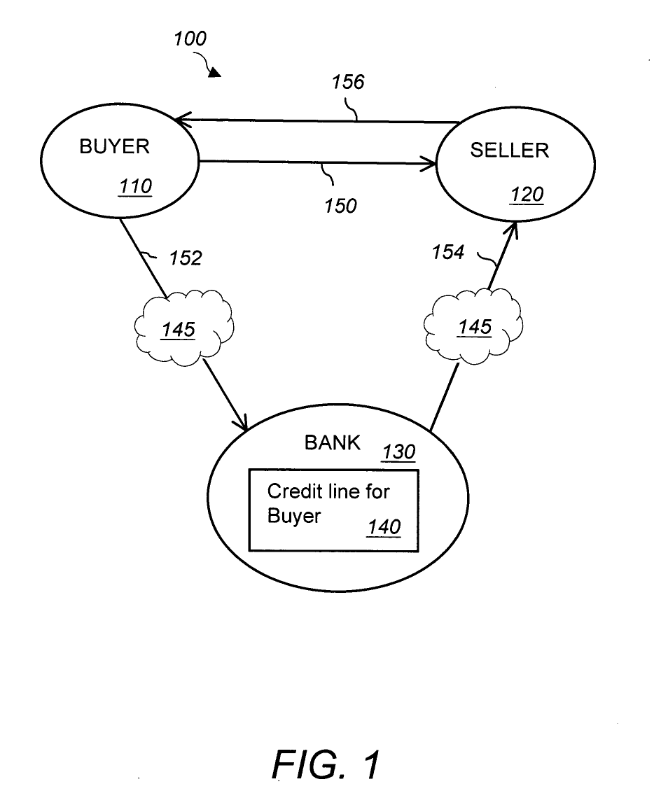

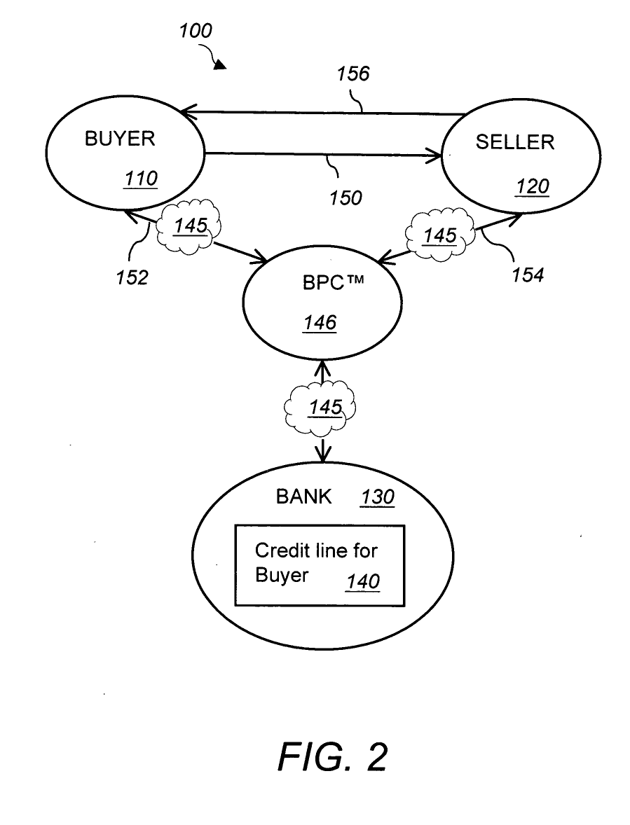

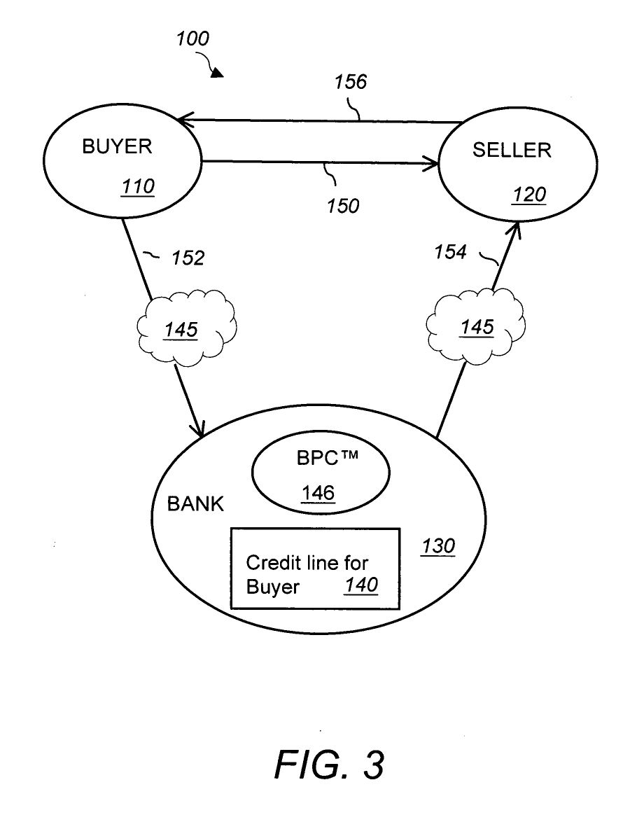

Referring to FIG. 1, a business payment system 100 of this invention includes a buyer 110, a seller 120 and a bank 130. The buyer 110 places a purchase order for a good or a service to the seller 120 (150). The purchase order is placed directly in a face-to face transaction. Alternatively, the order may be placed remotely, via the Internet, the phone or by mail. The seller 120, the buyer 110 and the bank 130 are connected via the Internet 145. The bank 140 provides a credit line 140 to the buyer 110 and this credit line is used to pay the seller 120 for goods and services. A credit line is a loan approved by a financial institution and available for the lender to draw on. The seller 120 receives the purchase order from the buyer 110 and then invoices the buyer 110 and ships the requested good or provides the service (156). The buyer 110 approves the invoice and instructs the bank 130 to pay the seller 120 via the previously arranged credit line 140 (152). The bank 130 pays the invoiced amount to the seller 120 after subtracting a transaction fee from the invoiced amount (154). In one example, the transaction fee is 2% of the purchase price for receiving payment within 30 days from the purchase date or 3% for receiving payment within 90 days from the purchase date. The business payment process is facilitated by a Business Payment Connection™ (BPC™) software 146, shown in FIG. 2 and FIG. 3. In the embodiment of FIG. 2, the BPC™ software 146 is stored in a third party server and is accessed by the buyer 110, the seller 120, and the bank 130 via the Internet 145. Alternatively, the BPC™ software 146 is installed in a bank server and is accessed by the seller 120 and the buyer 110 via the Internet 145 and by the bank 130 via the internal network, as shown in FIG. 3. Other examples of network 145 include a Virtual Private Network (VPN), a cable network, a data network, a telephone network, private voice and data networks, public voice and data networks, and mail or person to person. In other embodiments, the bank 130 maybe any financial institution including investment companies, credit card companies, loan companies, and money management companies. Bank 130 may pay the seller by transferring the payment electronically to the seller's bank account which may be located in the same bank 130 or in another financial institution. The business payment system 100 may include more than one buyer and more than one seller.

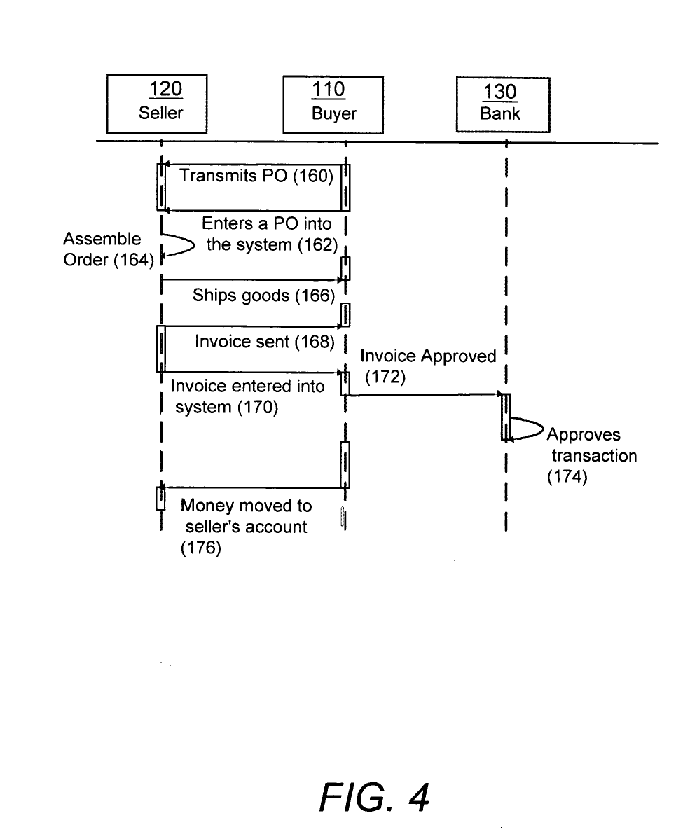

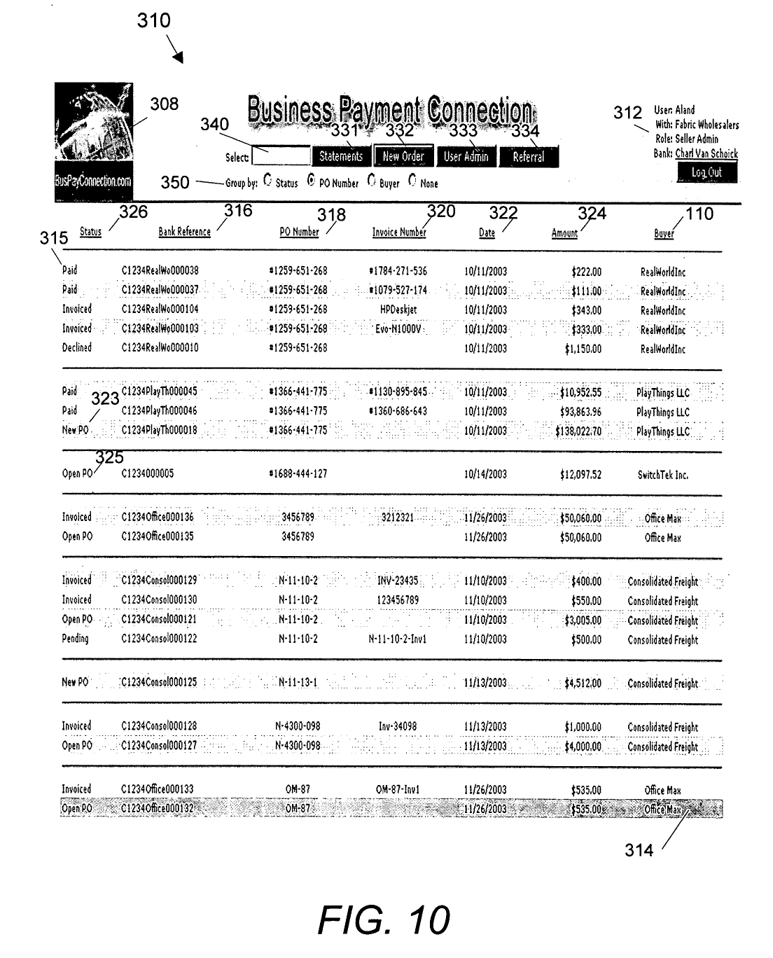

Referring to FIG. 4, a purchase and payment transaction within the system 100 includes the following steps. First a buyer 110 transmits a purchase order (PO) for goods or services to a seller 120 via normal means, i.e., Internet, phone, mail, or in a face-to-face interaction (160). Next, the buyer 110 enters a new transaction into the BPC™ system 146 and enters a PO number (162). Once the new transaction has been entered, the seller 120, the bank 130, and the buyer 110 can access the new transaction by login into the BPC™ system 146 via the Internet. The new transaction is displayed on a digital dashboard, shown in FIG. 10. The amount of the transaction is checked against the available credit 140 by the BPC™ system. Next, the seller 120 assembles the order (164), ships the goods or provides the services to the buyer 110 (166) and invoices the buyer 110 (168). The seller 120 also enters the invoice into the BPC™ system (170). The BPC™ system places the invoice in the new transaction and matches it with the PO number. As soon as the seller 120 enters the invoice into the BPC™ system 146, the buyer 110 is notified of the pending invoice. The buyer 110 then has 3 days to approve or disapprove the invoice. The buyer 110 approves the invoice (172) and the bank 130 is notified of the approved invoiced transaction. The bank 130 reviews the transaction and approves payment of the invoice (174). Once the bank approves payment for the transaction the invoiced amount is transferred from the buyer's credit line 140 to the seller's account (176).

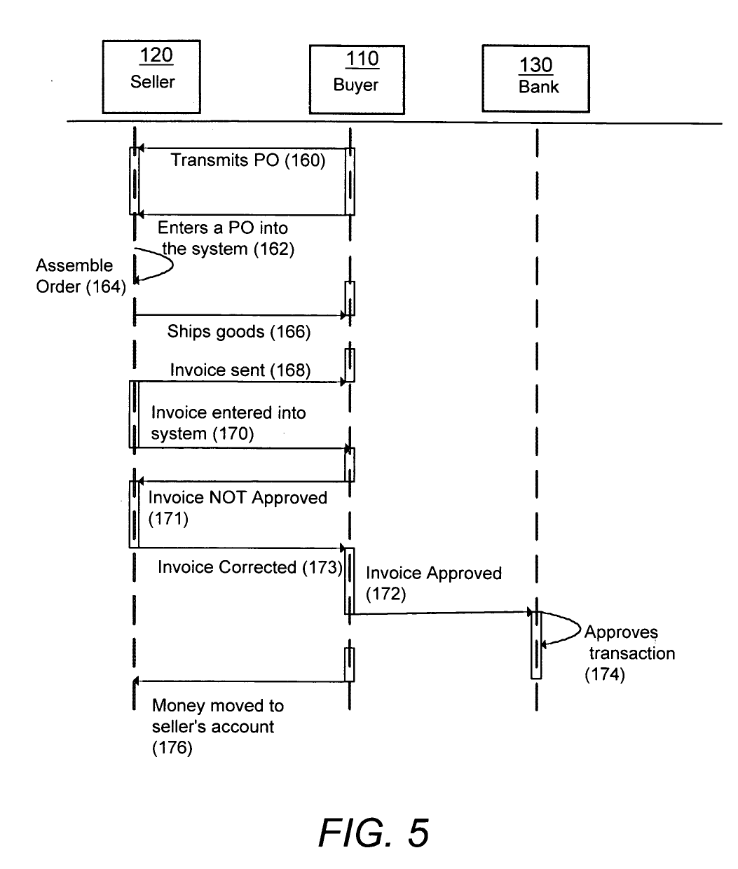

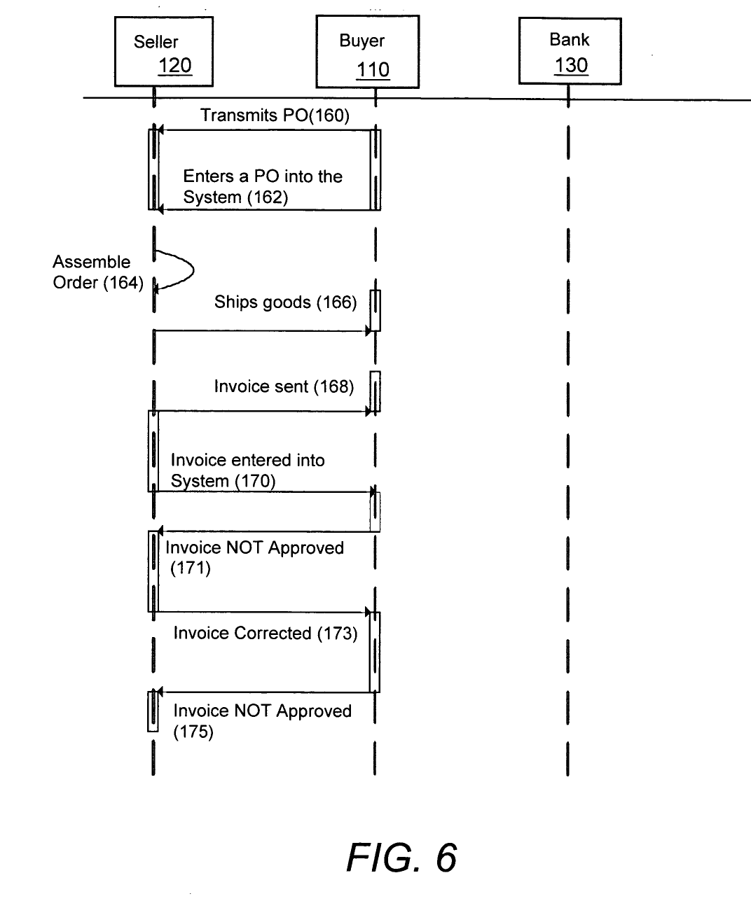

In case when there is a dispute and the buyer 110 does not approve the seller's 120 invoice, the BPC™ system notifies the seller (171), as shown in FIG. 5. There could be several reasons for not approving the invoice including goods damaged during shipping, an unexpected partial shipment, shipment of the wrong goods, quality defects, among others. When the buyer 110 rejects the invoice a reason must be provided. If both parties agree to specific changes to the invoice, the seller 120 corrects the invoice (173) and the buyer 110 then approves the corrected invoice (172). In the case when the buyer 119 rejects again the corrected invoice (175), shown in FIG. 6, the BPC™ system-based process stops. The BPC™ system alerts the seller 120 that there is a problem with the corrected invoice and at this point it is up to the seller 120 to work out the dispute directly with the buyer 110.

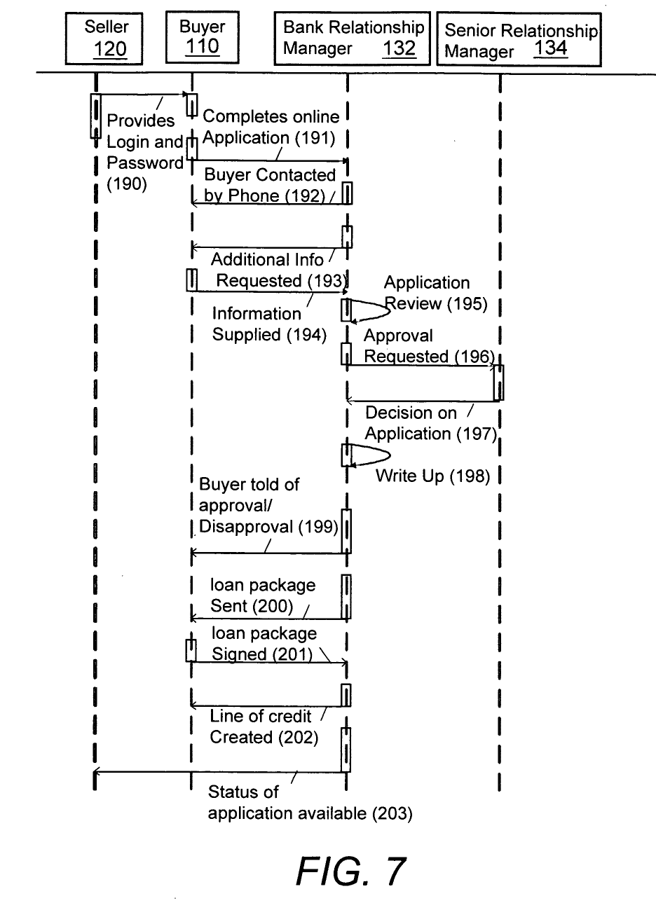

The transaction processes of FIG. 4, FIG. 5, and FIG. 6 assume that the seller 120 and the buyer 110 are already members of the business payment network and that the new buyer 110 has an existing line of credit 140 with the bank 130. In the case when a new buyer 110 is interested in using an existing BPC™ system of a seller 120 the buyer 110 needs to fill out an application to join the system and to open a credit line (140) with the bank 130. Referring to FIG. 7, seller 120 provides the buyer 110 with a login user name and a password to the BPC™ system 146 (190). The buyer 110 logs in and completes an online application (191). Shortly after the application is received a bank relationship manager 132 contacts the buyer 110 via phone (192). Either on this initial phone call or at a subsequent contact the bank 130 will request additional materials from the buyer 110 (193). The buyer 110 assembles the documents and sends them back to the bank 130 (194). The bank relationship manager 132 begins the application review (195). Further approval may be requested from a senior relationship manager 134, depending upon the size of the loan (196). The bank 130 makes a decision on the buyer's application (190). The possible outcomes of this step include, accepting the application, rejecting the application, or approving the application for an amount less than initially requested. The bank 130 starts the “write-up” (198) and communicates the decision to the buyer 110 (199). If the application is accepted then a formal loan package is sent to the buyer 110 (200) and the buyer 110 signs and returns the loan documents (201). If the loan is rejected then a letter is sent to the buyer 110 indicating why the loan was not approved. Upon receipt of the signed loan documents the bank 130 establishes a line of credit 140 (202). At this point the buyer 110 and the seller 120 can see the status of the line of credit 140 as approved (203). The bank 130 will also personally contact the buyer 110 to inform them of the bank's decision on the line of credit 140.

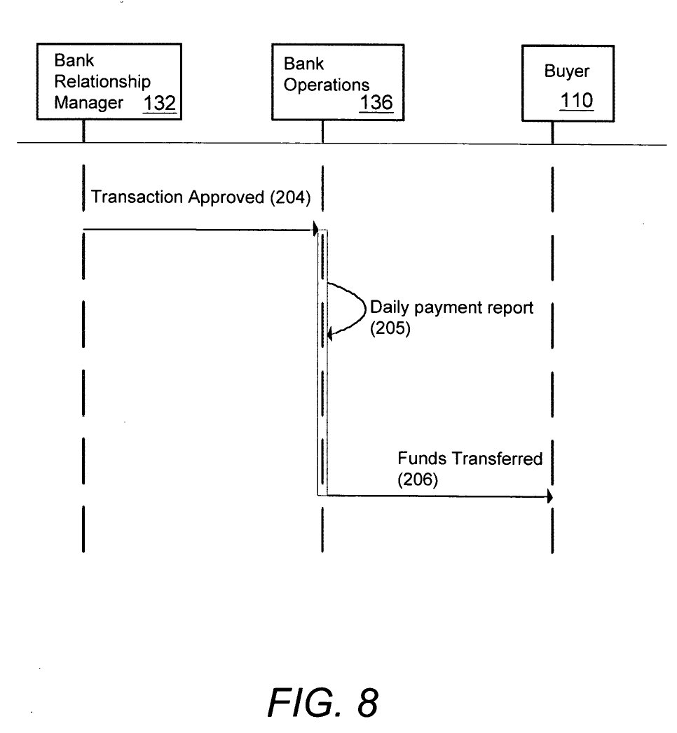

After the bank has approved a transaction 174, shown in FIG. 4, the funds must be debited against the buyer's line of credit 140, and then transferred to the account of the seller 176. The transfer of funds is done either manually or automatically as part of an Automated Clearing House (ACH) transfer for large transaction volumes. Referring to FIG. 8, the bank relationship manager 132 approves the transaction (204). The manager in bank operations 136 prepares a fund transfer report (205). This report provides necessary details to transfer funds such as account numbers, and Bank Routing numbers. This report is prepared daily and it details the funds that need to be transferred for that day. The data are entered into the external funds transfer systems and the funds are transferred (206). The Transaction/Balance interface reflects the funds transfer.

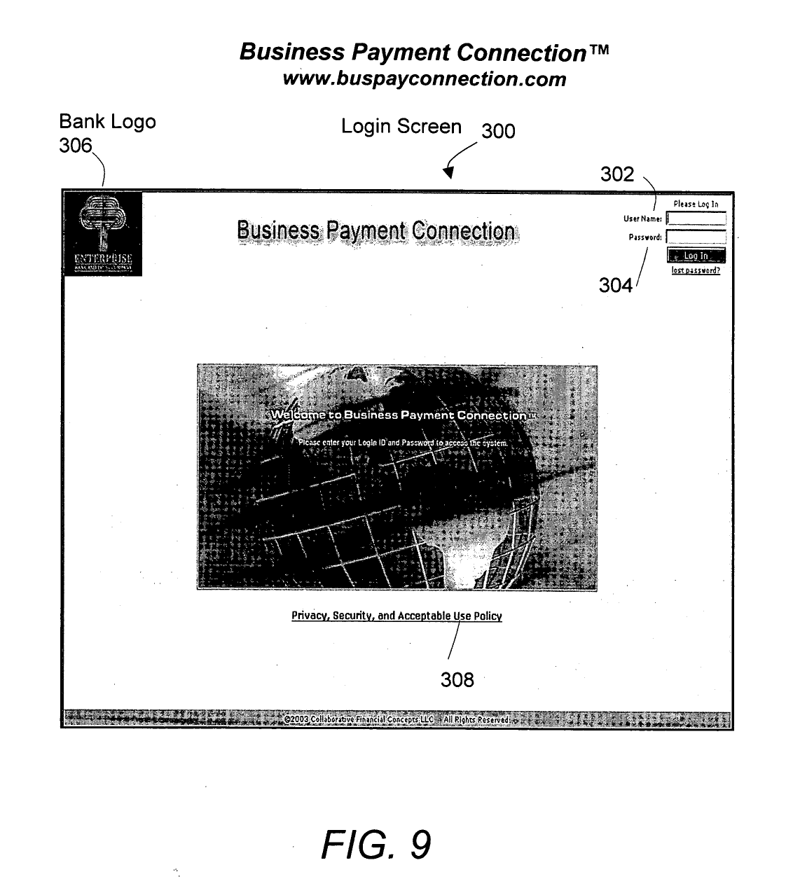

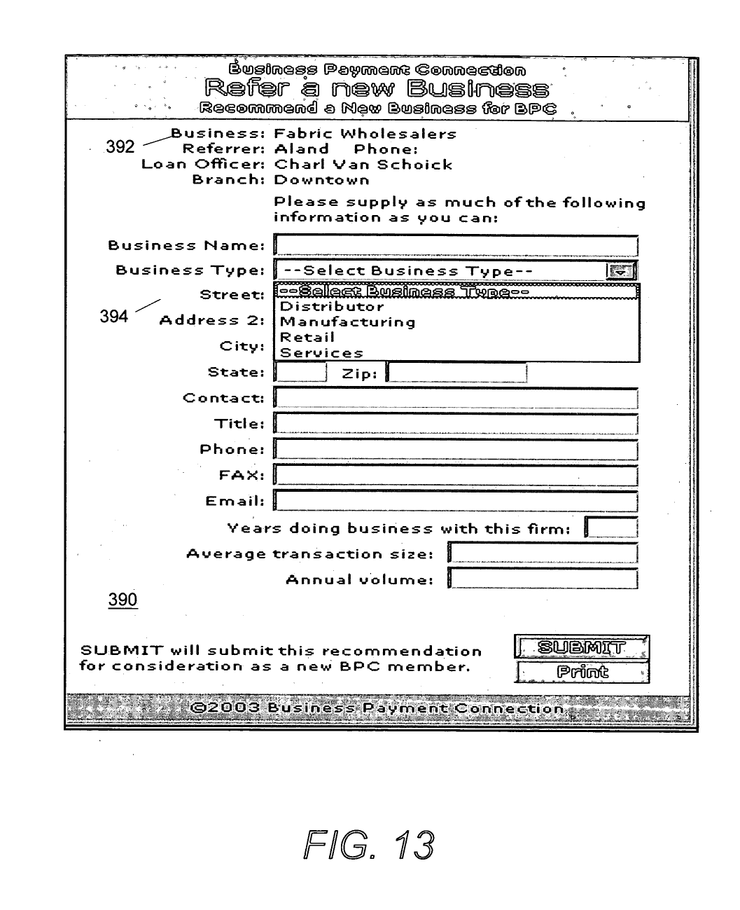

As was mentioned above, buyers 110, sellers 120 and banks 130 access the BPC™ system via a network connection 145, such as the Internet. The access can be direct by using the URL address “www.buspayconnection.com” or through a link off the bank's website. By clicking on the link or the URL address a user accesses the BPC™ system's login screen 300, shown in FIG. 9. In order to login into the BPC™ system a user needs to enter a user name 302 and a password 304. A user name 302 and a default password 304 are initially assigned by the system administrator. In the case of a new buyer the seller invites the buyer to join the BPC™ system network and assigns a user name and password. After the initial login the user is instructed to change their password. The login screen also includes the bank logo 306 and a link for the bank's privacy, security and acceptable use policy 308. A successful login leads to a dashboard user interface screen 310, shown in FIG. 10. Dashboard 310 is the user's homepage for all activities. Dashboard 310 includes the user's name, the name of the user's company, the user's role and the name of the bank contact 312. Dashboard 310 provides a collaborative view of a transaction register 314 for the buyer, seller and the bank. Each transaction 315 is identified by a bank reference number 316, a PO number 318, an Invoice number 320, the name of the buyer 110 or the seller 120, the date of the transaction 322, and the amount 324. The PO number 318 is entered by the buyer 110, the invoice number 320 is entered by the seller 120, and the bank reference number is a unique transaction tracking code entered by the bank 130. The name of the buyer 110 or the name of the seller 120 is listed depending on who is looking at the screen, i.e., the buyer 110 views the names of the sellers 120 and the seller 120 views the names of the buyers 110. The status 326 of each transaction is identified as “paid”, “invoiced”, “declined”, “pending”, “open PO”, “cancel”, “closed”, “disputed”, “approved”, “stopped” or as “new PO”. These status codes help track purchase orders and invoice workflow. The status codes are changed to reflect the actions of the buyer 110, seller 120 or the bank 130. When a buyer 110 enters a new PO number the status code is changed to “new PO”. When the seller 120 sees the new PO number and accepts it the status is changed to “open PO”. When the seller 120 decides not to accept the PO the status is changed to “cancel”. When the seller 120 enters a new invoice against the entered PO number the status is changed to “invoiced” and when the invoice is processed against the PO number the status is changed to “closed”. When the buyer 110 has an issue with the invoice payment the status is changed to “disputed” and when the buyer 110 authorizes the bank 130 to pay the invoice the status is changed to “approved”. When the bank 130 approves the payment and makes the payment to the seller 120 the status is changed to “paid” and when the bank 130 has issues with the invoice payment the status is changed to “stopped”. Dashboard 310 also includes function buttons 330 that bring up pop-up windows when a user clicks them. In one example, function buttons 330 include “statements” 331, “new order” 332, “user administrator” 333, and “referral” 334. The “referral” button brings up a window 390, shown in FIG. 13, that reflects the process of adding new buyers 110. The status codes for the referral process include “referral” when either a seller 120 or another buyer enters a new buyer in the system, “invited” when the bank sees this new customer lead, “applied” when the seller or buyer fills out an online application, “accepted” when the application is accepted by the bank, or “declined” when the application is declined by the bank. Dashboard 310 also includes a search field 340 and a group by function button 350. Search field 340 is used for quick transaction searches by a parameter such as PO number, invoice number, buyer's name, date, amount, status, or bank reference number. Status, PO number, and buyer can group transactions 315 by clicking on the corresponding group by button 350.

The BPC™ system 146 includes three modules, the bank module, the seller's module and the buyer's modules used by the banks 130, the sellers 120, and the buyers 110, respectively. The bank module is the bank's user interface and provides the functions of reviewing new applications, reviewing transactions, and reviewing total credit line usage. The seller's module is the seller's user interface and provides the functions of reviewing the status of new buyer applications and reviewing of transactions. The buyer's module is the buyer's user interface and allows the buyer to apply online for a line of credit, enter new transactions and review new transactions. As was mentioned above the BPC™ system 146 is located on a third party server, shown in FIG. 2, or at a bank server, shown in FIG. 3 and is accessed by buyers 110, sellers 120 and banks 130 via a network connection 145. The BPC™ system is up, running and available 24 hours/7 days per week or at least during standard work hours/5 days per week. It is accessible via a web browser such as Internet Explorer available by Microsoft Corporation or Navigator available by Netscape Corporation. It has a component-based architecture so that new modules and subsystems can be added to the already existing system with no problems. It allows for error recovery, i.e., in case of failure, the BPC™ system can get restarted as of the last logical module of computation. Users access the BPC™ system using a user name and password via the Web and each user is able to access the functionality in the system that he/she is entitled to. All user interface modules are designed in a way that allows for each bank and seller to have an interface with their logos, colors and fonts. All transmissions of data are via secure means.

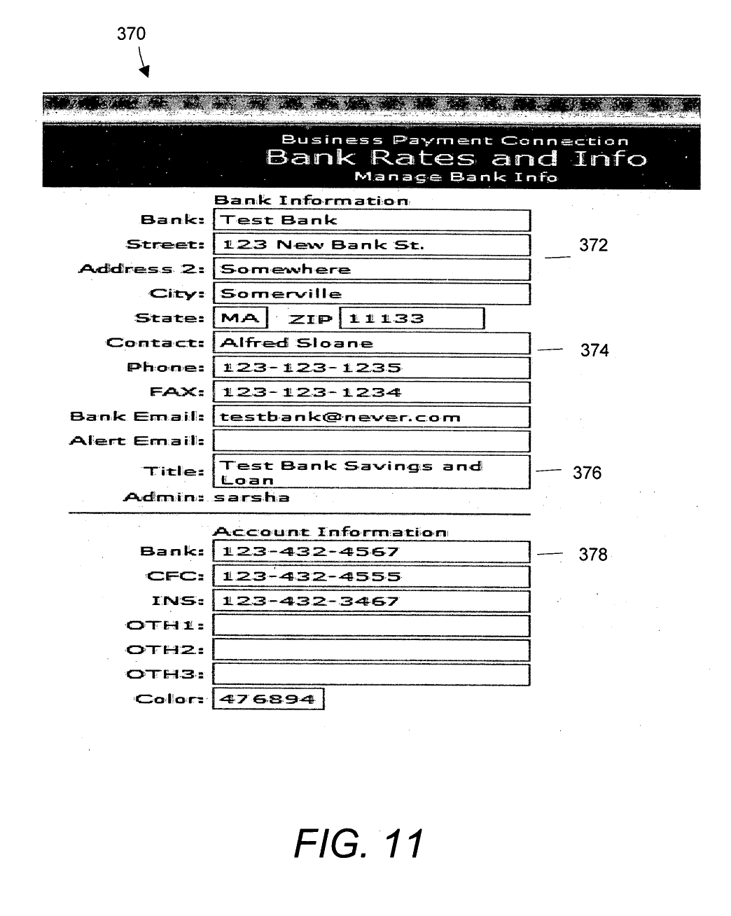

The bank module allows the bank 130 to receive applications and grant or deny the application for lines of credit. Once credit has been granted the bank 130 can review purchase transactions between the seller 120 and the buyer 110. Also included in the bank module is a reporting section, allowing the bank 130 to view activity by buyer 110, seller 120, or any other parameter. All bank users are greeted with a bank specific branded logon screen. The BPC™ system administrator assigns a user name and password to the bank administrator. The bank administrator logs into the BPC™ system and changes his password. The bank administrator then assigns bank user roles and bank user names. Table 1 summarizes the bank roles and key functions. Typical key roles include bank administrator, loan officer, loan operations officer, bank operations officer, bank branch manager, bank manager, bank auditor, and eservices officer. The bank administrator enters the initial bank set-up information, adds bank users and assigns permissions, adds new users for buyers and sellers, enters rates and fees, and views all transactions and all daily fund transfer requests. Referring to FIG. 11, the initial bank set-up information 370 includes the Help Desk person's contact information 372, i.e., e-mail, phone, and street address, that is displayed on the buyer's and seller's dashboard. The initial bank information also includes the loan officer's contact information 374, the title for the report/statement headings 376, and the account information 378. The account information 378 includes the buyer's account number, the seller's account, and the insurance company's account, among others.

TABLE 1
Bank Roles and Key functions

| Role | Key Functions |
|---|---|
| Bank Admin | *Initial Bank Set-up |
| | *Set Rates & Fees |
| | *Assign Users |
| | *View Daily Transaction Reports |
| | *Set-up Buyer/sellers |
| | *View Dashboard Transactions & |
| | Referrals from all Loan Officers |
| eServices | *View Dashboard Transactions & |
| | Referreals from all Loan Officers |
| | *Set-up Buyer/sellers |
| Loan Officer | *View Dashboard Transactions & |
| | Referrals from own customers |
| | *View Rates & Fees |
| | *Set-up Buyer/sellers |
| | *View and approve own customer |
| | transactions for payment |
| Loan Ops | *View-only Dashboard Transactions & |
| | Referrals from all Loan Officers |
| | *View & Edit Rates & Fees |
| | *View and approve all customer |
| | transactions for payment |
| Bank Ops | *View-only Dashboard Transactions & |
| | Referrals from all Loan Officers |
| | *Receive daily transaction file |
| | *Access file upload tool |

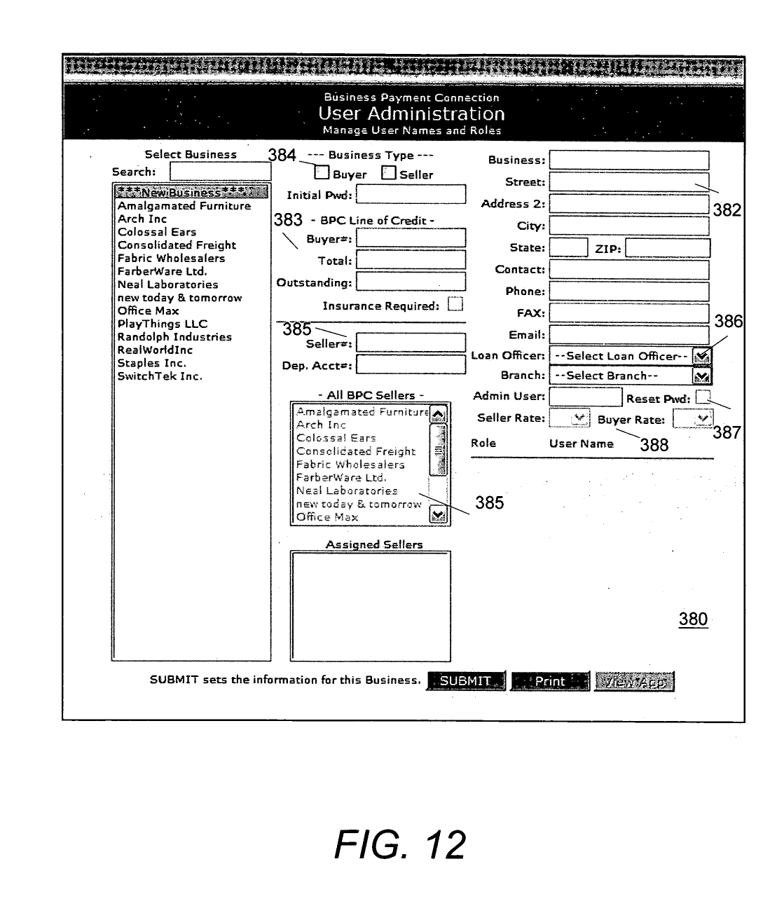

The bank administrator also enters new buyers and sellers into the system. Referring to FIG. 12, the new customer information 380 includes business name and contact information 382, business type 384, i.e. buyer or seller, buyer's line of credit information 383, seller's deposit account information, selects sellers for the buyer 385, select loan officer and bank branch 386, set initial user name and password 387, and set seller fee and buyer rate 388. The new customer information may be transferred from the application form, or the referral form or entered directly.

The bank administrator or the loan operations officer enters the rates and fees. The seller's fee is the sum of the bank fee, the BPC™ system fee and an optional trade credit insurance fee. The buyer rate is the Annual Percentage Rate (APR) associated with the line of credit and is set by the bank. Table 2 gives examples of typical seller's fees and buyer's rates. The 30 Day, 60 Day, or 90 day payment term is set by the seller for the buyer and the APR rate is set by the bank. A bank credit manager assigns the appropriate APR rate based on the interest rates, risk and credit history of the buyer.

TABLE 2
Rates and fees for BPC ™ system

| | Seller's fee to | | | Bank pays optional |
|---|---|---|---|---|
| Payment | the bank for | | Bank pays fee | fee to insurance |
| terms for | the transaction | Bank | for PBC ™ | company for trade |
| Buyer | % | fee | system % | credit insurance % |
| 30 Day | 2.0 | 0.5 | 1.00 | 0.5 |
| 60 Day | 2.5 | 0.65 | 1.35 | 0.5 |
| 90 Day | 3.0 | 0.75 | 1.75 | 0.5 |
| Year | | 6 | | |
| APR rate | | | | |
| for buyer | | | | |

The loan officer can see all dashboard transactions and referrals for the customers that are assigned to him or her, checks the seller's fees and buyer's APR, can set-up buyers and seller information and views and approves payment transactions for own customers. The loan operations officer can view dashboard transactions and referrals for all customers, can view and edit rates and fees, can view and approve payment transactions for all customers and manages all customer loans. The loan operations officer receives an e-mail alert for each transaction that needs approval, logs in the BPC™ system, opens the pending transfer statement for that day, approves and pays for each transaction and sets up the appropriate note on the bank system.

The bank operations officer can view dashboard transactions and referrals for all customers, receives a daily transaction file and can access a file upload tool. At the end of each day the bank operations officer logs in the BPC™ system, selects the daily funds transfer statement, prints or creates an Excel™ file with all buyer accepted invoices to be paid and loads the Excel™ file into the bank's loan processing system for transferring of funds. The bank operations officer also supplies to BPC™ system for each customer the current line of credit amount and the amount owed to the bank.

The e-services officer can view dashboard transactions and referrals for all customers, can set-up the buyer/seller information and can assign user name and passwords. The e-services officer tracks all BPC™ system new customer leads and referral forms. The referral form is an easy way for buyers and sellers to tell the bank to invite their clients to join the BPC™ system. Banks can also enter customer information into the referral form. Referring to FIG. 13, the referral form 390 includes the name of the business and person making the referral 392, and has fields 394 for the name of the referred business, contact information, years doing business with this customer, average transaction size and annual volume. The referral form 390 is submitted to the e-services and the e-services officer views the submitted referrals, assigns the referral to a loan officer and provides the new customer instructions by e-mail or phone on how to login into the BPC™ system using the “applicant” user name and a specific password.

The bank branch manager can view all BPC™ system activity for a particular branch and the bank manager can view all BPC™ system activity for the entire bank by loan officer and branch. The bank auditor has access to all BPC™ system activity for the bank plus all details for every transaction.

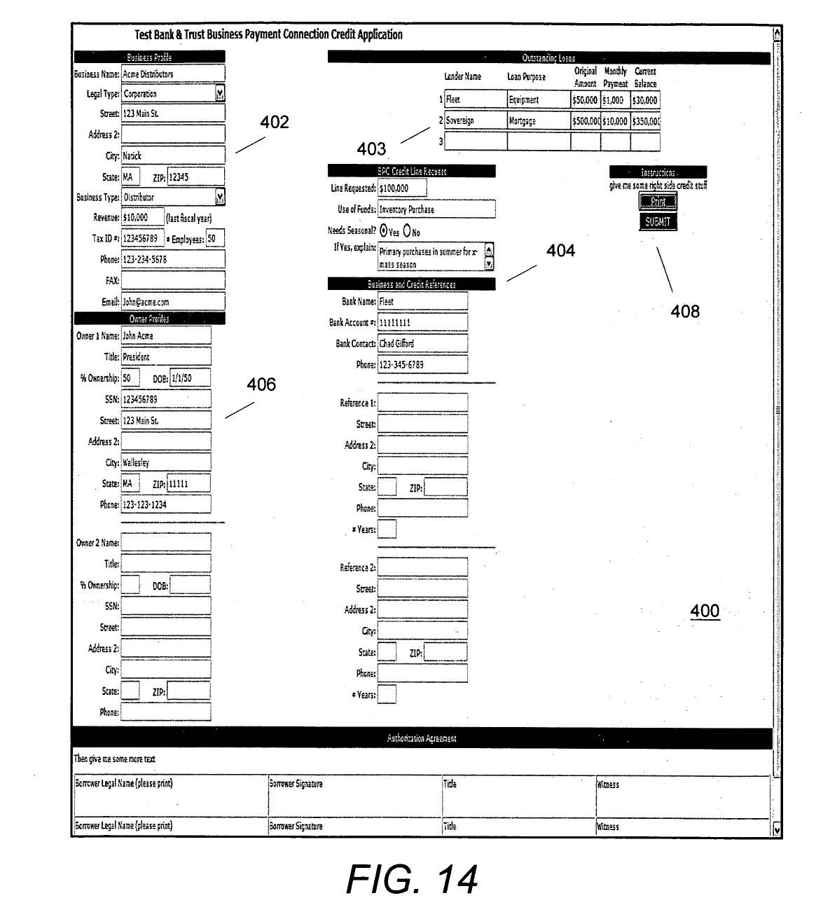

A critical function of the bank is to have new applications for lines of credit sent to them electronically. This enables the bank to react quickly in an efficient manner. The new applicant uses the generic user name of “applicant” and the specific password to login into the BPC™ system. The bank module has a screen for presenting the new applications. This new application screen is configurable by the bank. The bank can choose which fields are presented on the screen and in what order. The bank can also configure a filter on the data, so that applicants with a debt to equity ratios below a certain amount are presented. This functionality allows the loan officer to display the high quality applications at the top of the screen. As soon as the applicant submits an application, it can be viewed on this screen. Referring to FIG. 14, the applicant now sees a credit application 400 that has key information from the referral forms already transferred into the appropriate fields 402. The applicant then fills out the remaining fields 403, 404, 406 and submits 408 the credit application electronically to the bank. The applicant also prints a copy of the applications, signs and faxes it to the bank. Submitted credit applications are stored in the BPC™ system's central database and an email is sent to a designated email address at the bank.

The status of the submitted applications is changed to “applied” and the application is available for a bank review. The loan operations officer starts processing the application, and assigns a loan officer to the application. The loan officer follows the bank's credit evaluation procedures and based on the result he accepts or rejects the application for credit. The status of the application is then displayed as either “accepted” or “declined” A note can also be attached to the status information. When the application is accepted, the amount of the approved credit is entered and displayed. To complete the application, an initial password is selected for the new buyer, a new customer number is assigned, a loan officer and a bank branch are assigned and a list of sellers for this buyer is selected. The bank communicates the login information, i.e., a user name and an initial password to the new buyer and the new buyer uses this information to login into the BPC™ system. The first time he logs into the BPC™ system, the buyer is asked to change the initial password. New customer applications can also be filled out on a paper form and the information is then entered manually into the BPC™ system.

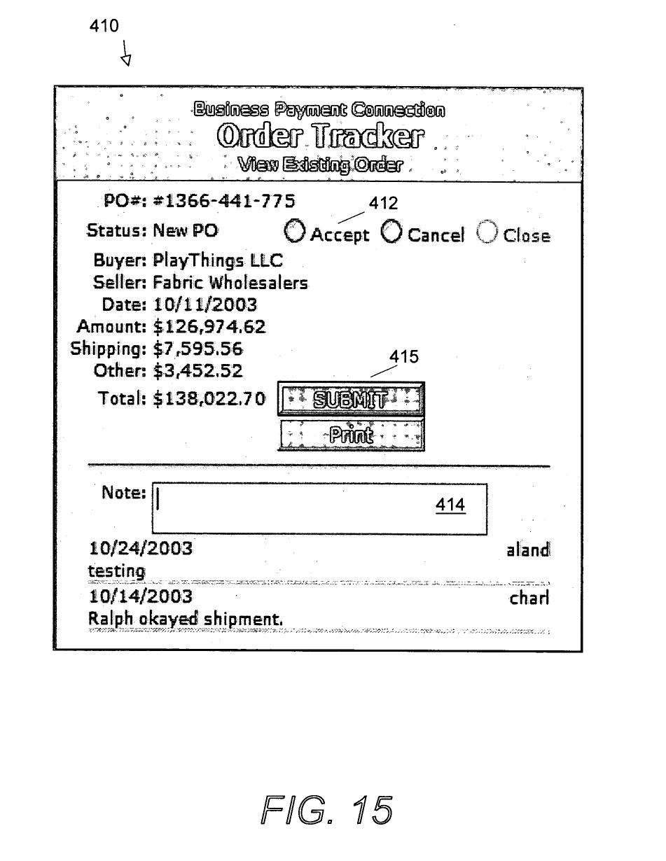

The seller's module is the user interface for the seller. In this module the seller can view all transactions associated with the seller's company on the electronic dashboard 310, shown in FIG. 10. The transactions can be grouped by category 350, and sorted by column headings, i.e., status 326, PO number 318, Bank reference number 316, invoice number 320, date 322, amount 324, and buyer 110. A line item 315 can be selected to view a specific transaction. Statements displaying paid invoices by month can be reviewed by clicking on the “statement” button 331. A new order for an existing buyer can be created by clicking in the “new order” button 332. This is useful for a manual entry of an order placed by phone, in person or mail. The seller's administrator can set up the roles and access privileges for the seller's personnel by clicking on the “user admin” 333 button. Referrals of new buyers are entered by clicking on the “referral” 334 button. By clicking on “new PO” order 323 an order tracker window 410 opens, shown in FIG. 15. The new PO order is accepted or canceled 412, a note may be attached 414 and the order is submitted 415. When the new PO order is accepted the status of the transaction is changed to “open order” 325, shown in FIG. 10.

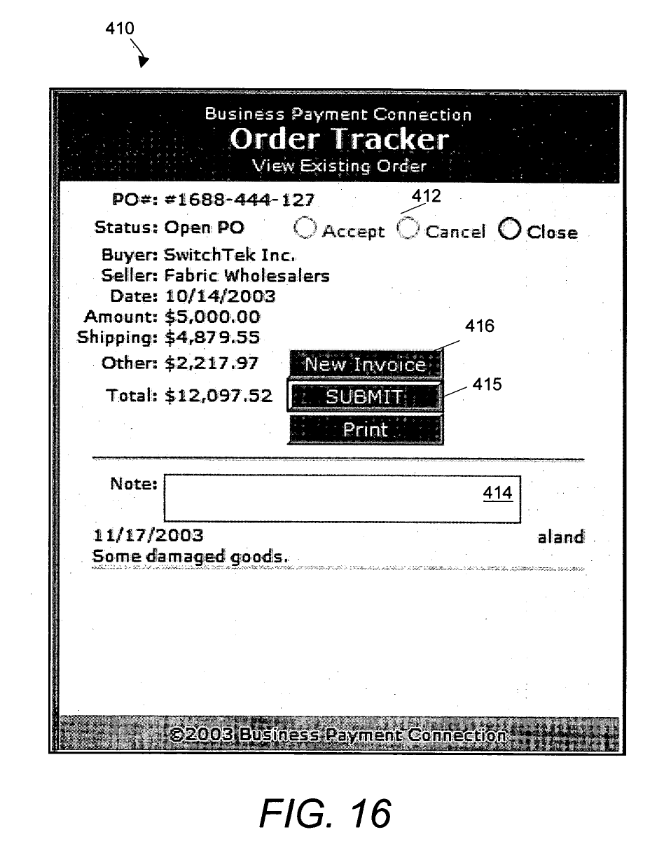

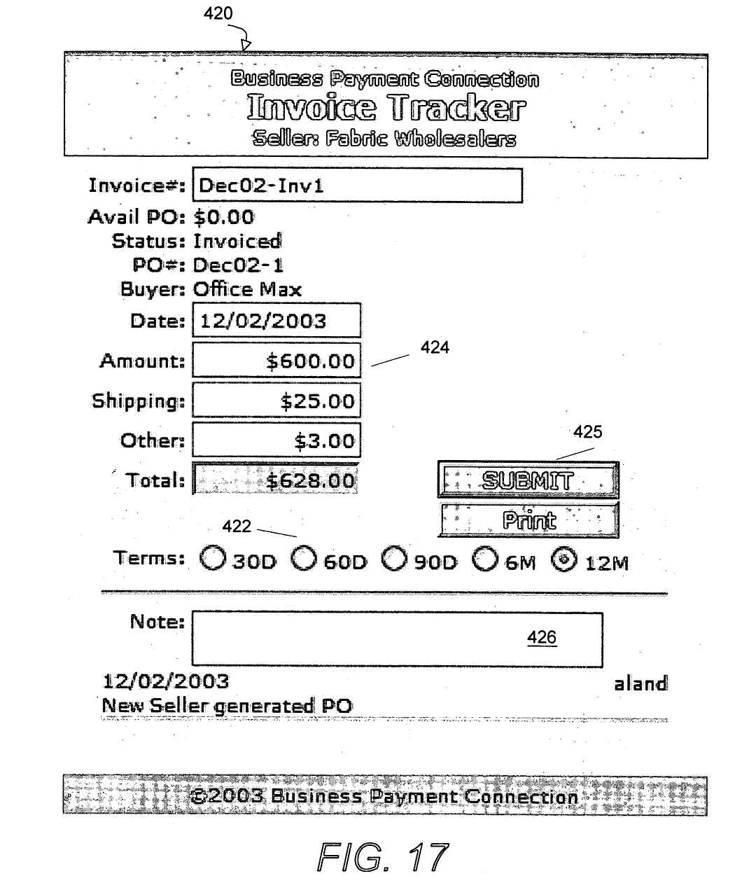

To receive payment for an order in the BPC™ system the seller must submit an invoice against an existing purchase order. This is the point where invoices and purchased orders are matched up. By clicking on an “open order” transaction 325 the order tracker window 410 opens and now a new invoice button 416 is displayed, shown in FIG. 16. By clicking on the “new invoice” button an invoice tracker window opens 420, shown in FIG. 17. The seller 120 selects the payment terms for this buyer 422, enters an invoice number, date, amount, shipping cost, shipping date and other costs 424 and submits the invoice 425. A note may also be added 426. The invoice amount can be equal or lower than the total PO amount. The invoice 425, once entered, is subject to the acknowledgment of the buyer, before payment. The buyer can change a “new PO” before the seller accepts it. If the buyer does not agree with the invoice, it will be sent back to the seller. At this point the seller has an opportunity to resubmit the invoice. If the buyer agrees with the modified version of the invoice then after the bank approves the transaction, money is moved from the buyer's credit line to the seller's account. In the case where the buyer disagrees with the revised invoice, the seller is alerted that there is a problem with the invoice. Then the automated payment process stops. The seller and the buyer must work out any issues with the invoice outside of the system. If the invoiced amount is higher than the original PO amount the transaction is closed and a new transaction is created.

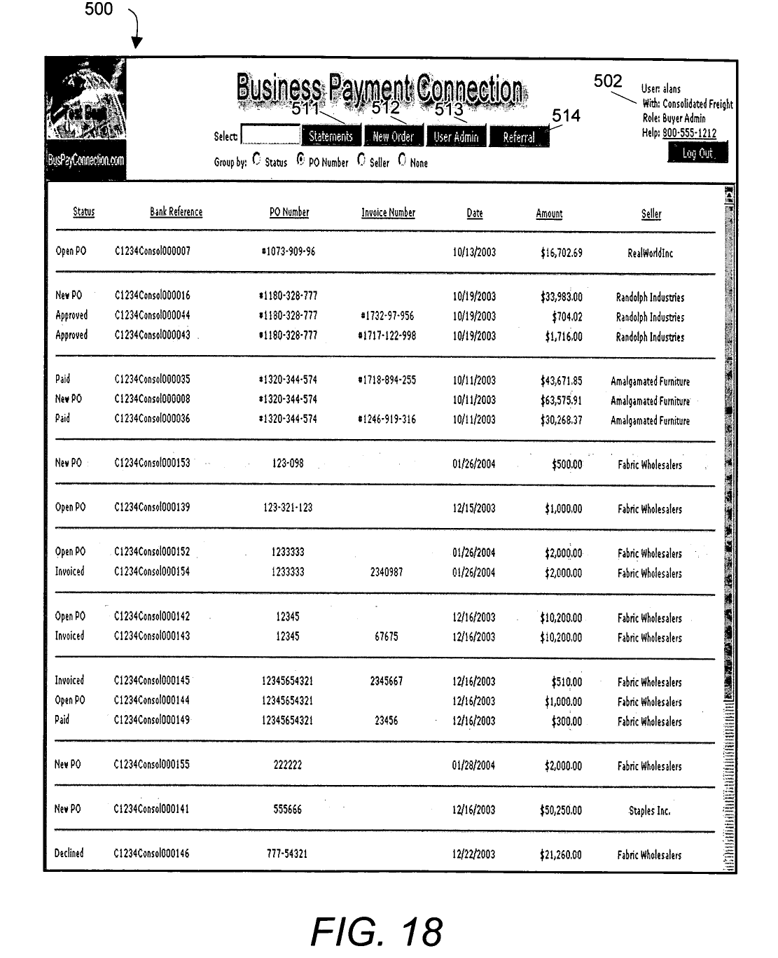

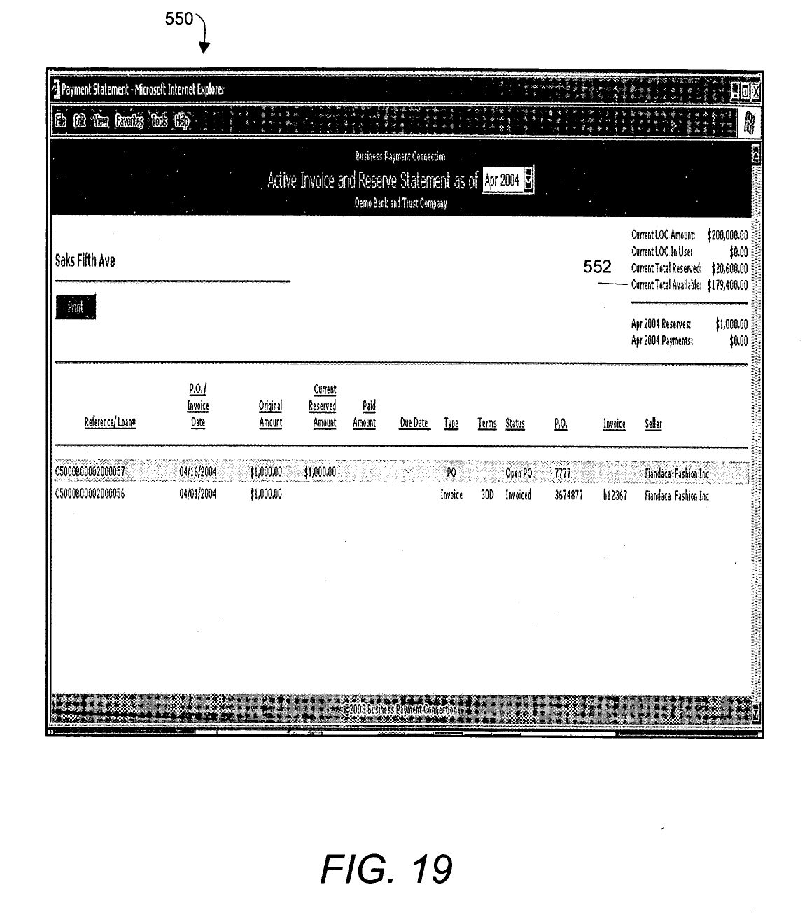

The buyer module allows the buyer to use a temporary user name and a password provided by the seller to apply for a line of credit at the bank. Once the bank has granted a line of credit the buyer can place new purchase orders and track their status. Referring to FIG. 18, the buyer clicks the “new order” 512 button, in the buyer electronic dashboard 500 to place an order. An order tracker window 410, shown in FIG. 15, opens and the buyer enters the seller's name, PO number and amount, preferred shipping method and submits the order by clicking the submit button. A “new PO” line 325 and 503 will appear in the electronic dashboards of the seller 310, shown in FIG. 10, and the electronic dashboard of the buyer 500, shown in FIG. 18, respectively. The buyer can view a statement of all active invoices by clicking on the “statement” button 511. The monthly statement of active invoices and reserves 550, shown in FIG. 19, displays the total line of credit, amount in use, amount reserved for current orders and the available amount 552. The line of credit that was established through the BPC™ system is only available through the BPC™ system, i.e., it is a “closed” system. The BPC™ system keeps track of all transactions and synchronizes them with the bank loan system. It also maintains and reports the total credit line and total outstanding orders on a daily basis. It also keeps track of all transactions, reserves dollars for outstanding orders and calculates a buyer's available credit. The buyer administrator 502 can view all transactions on the electronic dashboard of FIG. 18, group transactions by category, sort by column, or select a line item to view a PO tracker, shown in FIG. 15, or an Invoice tracker window, shown in FIG. 17. The buyer administrator can also create new orders, view the statements of credit line status, paid invoices, and reserve orders. The buyer administrator can set up other internal company users and fill out a referral form for another buyer or seller to join the business payment network. When a seller places an invoice in BPC™ system, against a purchase order, the buyer has a certain days to acknowledge the invoice. The number of days is know as the inspection period and is determined by the seller, when the invoice is placed against the purchase order. When the buyer acknowledges the invoice and accepts it the invoice is presented to the bank to transfer money from the buyer's line of credit account to the seller's account. If after the inspection period, the buyer neither acknowledges nor disapproves the invoice, it is automatically acknowledged by the system and payment is made to the seller. The purpose of the acknowledgement step in the workflow is to give the buyer a chance to examine the goods and check them against the invoice. It should not allow the buyer to delay payment of legitimate invoices.

Several embodiments of the present invention have been described. Nevertheless, it will be understood that various modifications may be made without departing from the spirit and scope of the invention. Accordingly, other embodiments are within the scope of the following claims.

1. An online business payment method that provides credit and cash flow management comprising:
providing at least one seller of products or services, at least one buyer of said products or services, a financial institution and a business payment system, wherein said at least one seller, said at least one buyer and said financial institution access said business payment system via a network connection;
establishing a credit line for said at least one buyer by said financial institution;
placing a purchase order for a product or service by said at least one buyer to said at least one seller;
registering a purchase transaction into said business payment system and entering a purchase order number into said business payment system;
accepting said purchase order by said at least one seller and providing said product or service to said at least one buyer;
sending an invoice by said at least one seller to said at least one buyer and entering said invoice into said business payment system against said purchase order number;
approving said invoice by said at least one buyer and entering said approval into said business payment system;
notifying said financial institution of said approved invoice by said business payment system;
approving payment of said approved invoice by said financial institution;
paying said invoice by transferring money from said at least one buyer's credit line to an account of said at least one seller; and
wherein said business payment system provides a collaborative platform for said at least one seller, said at least one buyer and said financial institution for viewing status of said purchase transaction, said establishing of a credit line, said registering of said purchase transaction, said entering and accepting of a purchase order number, said entering and approving of said invoice, said notifying of said financial institution, said approving of payment and said paying of said invoice.

2. The method of claim 1 further comprising setting a payment term for said invoice by said seller.

3. The method of claim 2 wherein said payment term is selected from a group consisting of 30 days, 45 day, 60 days, and 90 days.

4. The method of claim 2 further comprising paying a seller's fee to said financial institution by said at least one seller upon receiving said payment.

5. The method of claim 4 wherein said seller's fee depends upon said payment term.

6. The method of claim 5 wherein said seller's fee comprises a percentage of said invoice.

7. The method of claim 2 further comprising paying interest to said financial institution for said credit line by said at least one buyer when said payment term is not met.

8. The method of claim 2 further comprising converting said credit line into a loan and paying interest to said financial institution for said loan by said at least one buyer when said payment term is not met.

9. The method of claim 8 further comprising purchasing insurance for said loan by said financial institution.

10. The method of claim 1 wherein said invoice approval and said transferring of money occurs within less than five day after said sending of said invoice to said at least one buyer.

11. The method of claim 1 wherein after sending said invoice by said at least one seller to said at least one buyer further comprising:
not approving said invoice by said at least one buyer and notifying said at least one seller of an error in said invoice; and
correcting said error in said invoice by said at least one seller and resending said invoice to said at least one buyer.

12. The method of claim 1 wherein said establishing of a credit line comprises:
login into said business payment system;
accessing and filling out an online credit application and submitting said online credit application to said financial institution via said business payment system;
reviewing said credit application by said financial institution;
approving said credit application by said financial institution and notifying said at least one buyer and said at least one seller of said approval.

13. The method of claim 12 wherein after said filling out of said online credit application further comprising requesting and receiving additional information from said at least one buyer by said financial institution.

14. The method of claim 1 further comprising referring at least a second buyer or a second seller to join said online business payment system.

15. The method of claim 1 wherein said at least one buyer, said at least one seller and said financial institution access said business payment system via a secure login process and said access is controlled based on previously set permissions.

16. The method of claim 15 wherein said login process comprises entering a user name and a password.

17. The method of claim 1 wherein said online business payment system comprises:
a server connected to said network, said server comprising a central processing unit and a storage medium;
a business payment software stored in said storage medium and adapted to run on said central processing unit and comprising instructions for performing said establishing of said credit line, said registering of said purchase transaction, said entering of said purchase order number and invoice, said approving of said invoice, said notifying said financial institution of said approved invoice and registering of said paying of said invoice.

18. The method of claim 17 wherein said business payment software comprises a buyer's module, a seller's module, and a financial institution's module and wherein said buyer's module, said seller's module, and said financial institution's module comprise a buyer's user interface, a seller's user interface and a financial institution's user interface, respectively, and are accessed and viewed by said at least one buyer, said at least one seller, and said financial institution, respectively, via a web browser.

19. The method of claim 18 wherein said business payment software further comprises instructions for presenting an electronic dashboard for displaying information of said purchase transaction via said buyer's user interface, said seller's user interface and said financial institution's user interface.

20. The method of claim 19 wherein said information of said purchase transaction comprises a status, a bank reference number, a purchase order number, an invoice number, a date, an amount, name of said at least one buyer and name of said at least one seller.

21. The method of claim 20 wherein said information of said purchase transaction is selectively viewed by said at least one buyer, said at least one seller and said financial institution based on previously set permissions.

22. The method of claim 21 wherein said buyer's module provides the functions of applying online for a line of credit, registering said purchase transaction, and reviewing said purchase transaction.

23. The method of claim 22 wherein said seller's module provides the functions of reviewing statue of new buyer application for a line of credit, and reviewing said purchase transaction.

24. The method of claim 23 wherein said financial institution's module provides the functions of receiving and reviewing new buyer application for a line of credit, reviewing said purchase transaction, and reviewing total credit line usage.

25. The method of claim 24 wherein said buyer's module, said seller's module and said financial institution's module further provide the function of referring a new buyer or a new seller.

26. The method of claim 1 wherein said network is selected from a group consisting of the Internet, a Virtual Private Network, a cable network, a data network, a telephone network, a private voice and data network, and a public voice and data network.

27. The method of claim 1 wherein said financial institution is selected from a group consisting of a bank, an investment company, a credit card company, a loan company, a money management company, and an insurance company.

28. The method of claim 1 wherein said order is place by a method selected from a group consisting of online, telephone, mail, and in person.

29. The method of claim 1 wherein said account of said at least one seller is located in said financial institution.

30. A business payment system that provides a collaborative platform for managing credit and cash flow between at least one seller of products or services, at least one buyer of said products or services and a financial institution comprising:
an electronic dashboard for registering and displaying a purchase transaction for said products or services;
an electronic application for establishing a line of credit for said at least one buyer at said financial institution wherein said line of credit is used for paying said at least one seller for said products or services;
means for receiving and sending communications from and to said business payment system, said at least one seller, said at least one buyer and said financial institution; and
wherein said business payment system is accessed by said at least one buyer, said at least one seller and said financial institution via a secure network connection.

31. The system of claim 30 further comprising a server connected to said network and comprising a central processing unit and a storage medium for running and storing a business payment software, respectively, and wherein said business payment software comprises said electronic dashboard, said electronic application for credit line and said communications means.

32. The system of claim 30 wherein said communications comprise registering a purchase transaction, entering a purchase order number, entering an invoice number, entering approval of an invoice number, sending notification of said invoice approval, sending instruction to pay said invoice number, selecting a payment term, entering a user name and password, changing the user name and password, filling out and submitting a line of credit application and sending notification of status of said line of credit application.

33. The system of claim 31 wherein said business payment software comprises a buyer's module, a seller's module, and a financial institution's module and wherein said buyer's module, said seller's module, and said financial institution's module comprise a buyer's user interface, a seller's user interface and a financial institution's user interface, respectively, and are accessed and viewed by said at least one buyer, said at least one seller, and said financial institution, respectively, via a web browser.

34. The system of claim 30 wherein said purchase transaction comprises a purchase order number, a transaction status, a financial institution reference number, an invoice number, a date, an amount, said buyer's name and contact information, said seller's name and contact information, and said financial institution's name and contact information.

35. The system of claim 34 wherein said purchase transaction is selectively viewed by said at least one buyer, said at least one seller and said financial institution based on previously set permissions.

36. The system of claim 34 further comprising a payment term for said purchase transaction.
